(19) United States
(12) Patent Application Publication
(10) Pub. No.: US 2014/0049236 A1
(43) Pub. Date: Feb. 20, 2014

(54) SWITCH CONTROL CIRCUIT, CONVERTER INCLUDING THE SAME AND DRIVING METHOD THEREOF

(71) Applicant: FAIRCHILD KOREA SEMICONDUCTOR LTD., Bucheon (KR)

(72) Inventors: Jae-Yong LEE, Seongnam-si (KR); Ji-Hoon JANG, Incheon-Si (KR); Young-Je LEE, Bucheon-si (KR)

(73) Assignee: FAIRCHILD KOREA SEMICONDUCTOR LTD., Bucheon (KR)

(21) Appl. No.: 13/964,173

(22) Filed: Aug. 12, 2013

(30) Foreign Application Priority Data
Aug. 14, 2012 (KR) 10-2012-0089122

(51) Int. Cl. H02M 3/158

(52) U.S. Cl. CPC H02M 3/158
USPC 323/271

(57) ABSTRACT

Disclosed are a switch control circuit, a converter including the same, and a driving method thereof. The converter includes an inductor for storing energy of an input end and providing the same to an output end, a first switch coupled between the inductor and a ground, and a switch control circuit for controlling the first switch by comparing a ramp voltage that corresponds to a current that flows through the first switch and a first voltage that corresponds to an output voltage of the output end. The switch control circuit compares the ramp voltage and the first reference voltage to change the slope of the ramp voltage.

### CROSS-REFERENCE TO RELATED APPLICATION

This application claims priority to and the benefit of Korean Patent Application No. 10-2012-0089122 filed in the Korean Intellectual Property Office on Aug. 14, 2012, the entire contents of which are incorporated herein by reference.

### BACKGROUND OF THE INVENTION

(a) Field of the Invention

The present invention relates to a switch control circuit, a converter including the same, and a driving method thereof.

(b) Description of the Related Art

A converter converts a predetermined input voltage into a desired output voltage. The converter is installed in various types of electronic devices and is used to generate various power supply voltages.

In general, the converter includes an inductor, a diode, a main switch, and an output capacitor, and it performs a regulation operation for maintaining an output voltage. The regulation operation compares first information corresponding to an output voltage charged in the output capacitor and second information corresponding to a current flowing to the inductor, and controls an on/off time (duty) of the main switch.

The second information is expressed as a ramp voltage which has a predetermined slope. The ramp voltage having a predetermined slope is used to determine a turn-off time of the main switch, and the slope of the ramp voltage may not be set to be a desired slope because of a characteristic change of a circuit element for generating the ramp voltage. The slope to be desirably set is a first slope and it is changeable to a second slope (that is greater than the first slope) because of a characteristic of a circuit element so a maximum current level flowing to the inductor can be reduced to be less than a predetermined maximum current level. When the maximum current level of the main switch is reduced to be less than the predetermined level, energy to be stored in the inductor is reduced (i.e., power to be supplied by an input side is reduced) so desired output cannot be acquired.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a switch control circuit for providing a stable output, a converter including the same, and a driving method thereof.

An exemplary embodiment of the present invention provides a converter.

The converter includes: an inductor for storing energy of an input end and providing the same to an output end; a first switch coupled between the inductor and a ground; and a switch control circuit for controlling the first switch by comparing a ramp voltage that corresponds to a current that flows through the first switch and a first voltage that corresponds to an output voltage of the output end, and changing a slope of the ramp voltage by comparing the ramp voltage and a first reference voltage.

The switch control circuit changes the slope of the ramp voltage to a second slope that is gentler than a first slope from the first slope in a first condition in which the ramp voltage is less than the first reference voltage.

The switch control circuit changes the slope of the ramp voltage to the second slope from the first slope when the first condition continuously occurs at least twice.

The switch control circuit includes a ramp voltage generator for generating the ramp voltage, and the ramp voltage generator includes: a capacitor having a first end coupled to a power and charging a predetermined voltage; a second switch having a first end coupled to a second end of the capacitor; a variable resistor coupled between a second end of the second switch and a ground; a differential amplifier having a first input end for receiving information on the current, a second input end coupled to a second end of the second switch, and an output end coupled to a control end of the second switch; and an automatic resistor controller for changing resistance of the variable resistor, wherein a voltage at the second end of the capacitor is the ramp voltage.

In a first condition in which the ramp voltage is less than the first reference voltage, the automatic resistor controller controls the variable resistor so as to increase resistance of the variable resistor.

The variable resistor includes a first resistor and a second resistor that are coupled in series, the ramp voltage generator further includes a third switch coupled to both ends of the second resistor, and the automatic resistor controller turns off the third switch in the first condition.

The automatic resistor controller includes: a delay generator for delaying a signal that is input to a control end of the first switch for a predetermined time; a comparator for receiving the ramp voltage and the first reference voltage and comparing them; an AND gate for receiving a delay signal of the delay generator and a comparison result of the comparator; a sense period generator for generating a signal having a high level during a first interval; and a measurement data generator for receiving outputs of the AND gate and the sense period generator, and outputting a signal for turning off the third switch when the first condition is satisfied during the first interval.

The ramp voltage generator further includes: a transistor having a first end coupled to the second end of the capacitor and a second end coupled to the control end; and a third switch coupled between the power and the second end of the transistor.

The switch control circuit includes: an error amplifier for generating the first voltage by amplifying a difference between the output voltage and a second reference voltage; and a PWM controller for comparing the first voltage and the ramp voltage and outputting a signal for turning off the first switch.

The switch control circuit changes a slope of the ramp voltage to a third slope that is gentler than the second slope from the second slope when the slope of the ramp voltage is changed to the second slope and satisfies the first condition.

The inductor includes a first inductor having a first end coupled to the input end and a second inductor having a first end coupled to a second end of the first inductor, and the converter further includes: a second switch coupled in parallel to the first switch; and a resistor having a first end coupled to the second switch and a second end coupled to the ground, and the first switch is coupled between the second end of the first inductor and the ground, and a voltage at the first end of the resistor is supplied to the switch control circuit.

Another embodiment of the present invention provides a method for driving a converter.

The method for driving a converter includes: providing an inductor having a first end coupled to an input end; providing a switch coupled between a second end of the inductor and a ground; generating a first voltage that corresponds to an output voltage of an output end; generating a ramp voltage that corresponds to a current that flows through the switch; comparing a ramp voltage and a first reference voltage and changing a slope of the ramp voltage; and comparing the ramp voltage and the first voltage and controlling the switch.

The changing of a slope of the ramp voltage includes: determining whether the ramp voltage is less than the first reference voltage; and changing the slope of the ramp to a second slope that is gentler than a first slope from the first slope when the ramp voltage is determined to be less than the first reference voltage.

The changing of a slope of the ramp voltage further includes changing the slope of the ramp voltage to a third slope that is gentler than the second slope from the second slope when the ramp voltage is determined to be less than the first reference voltage after the slope of the ramp voltage is changed to the second slope.

Still another embodiment of the present invention provides a switch control circuit in a converter including an inductor having a first end coupled to an input end and a switch coupled between the inductor and a ground.

The switch control circuit includes: a ramp voltage generator for generating a ramp voltage that corresponds to a current that flows through the switch; and a PWM controller for comparing a first voltage that corresponds to an output voltage of the converter and the ramp voltage, and generating a signal for turning off the first switch, wherein the ramp voltage generator compares the ramp voltage and the first reference voltage to change the slope of the ramp voltage.

The ramp voltage generator changes the slope of the ramp voltage to a second slope that is gentler than a first slope from the first slope when the ramp voltage is less than the first reference voltage.

The ramp voltage generator includes: a capacitor having a first end coupled to a power and charged with a predetermined voltage; a first switch having a first end coupled to a second end of the capacitor; a variable resistor coupled between a second end of the first switch and a ground; a differential amplifier having a first input end for receiving information on the current, a second input end coupled to a second end of the first switch, and an output end coupled to a control end of the second switch; and an automatic resistor controller for changing resistance of the variable resistor, and a voltage at a second end of the capacitor is the ramp voltage.

The variable resistor includes a plurality of resistors that are coupled in series, the ramp voltage generator further includes a plurality of switches that are coupled in parallel to the plurality of resistors, and the automatic resistor controller turns off at least one of the plurality of switches to change resistance of the variable resistor when the ramp voltage is less than the first reference voltage.

The automatic resistor controller includes: a delay generator for delaying a signal that is input to a control end of the switch for a predetermined time; a comparator for receiving the ramp voltage and the first reference voltage and comparing them; an AND gate for receiving a delay signal of the delay generator and a comparison result of the comparator; a sense period generator for generating a signal that has a high level during a first interval; and a measurement data generator for receiving outputs of the AND gate and the sense period generator, and outputting a signal for turning off at least one of the plurality of switches when the ramp voltage is less than the first reference voltage during the first interval.

The ramp voltage generator further includes a transistor having a first end coupled to a second end of the capacitor and a second end coupled to a control end, and a second switch coupled between the power and the second end of the transistor.

According to the embodiments of the present invention, the maximum current level is maintained by changing the slope of the ramp voltage under a predetermined condition, and the stable output is accordingly acquired.

### BRIEF DESCRIPTION OF THE DRAWINGS

FIG. 1 shows a converter according to an exemplary embodiment of the present invention.

FIG. 2 shows a principle for a ramp voltage generator according to an exemplary embodiment of the present invention to generate a ramp voltage (Vramp).

FIG. 3 shows an internal configuration of an automatic resistor controller according to an exemplary embodiment of the present invention.

FIG. 4 shows a timing diagram for showing waveforms of respective signals in an automatic resistor controller according to an exemplary embodiment of the present invention.

FIG. 5 shows a diagram for sequentially changing a slope of a ramp voltage (Vramp).

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “connected” to another element, the element may be “directly connected” to the other element or “electrically connected” to the other element through a third element. In addition, unless explicitly described to the contrary, the word “comprise” and variations such as “comprises” or “comprising” will be understood to imply the inclusion of stated elements but not the exclusion of any other elements.

A switch drive circuit, a converter including the same, and a driving method thereof according to exemplary embodiments of the present invention will now be described with reference to accompanying drawings.

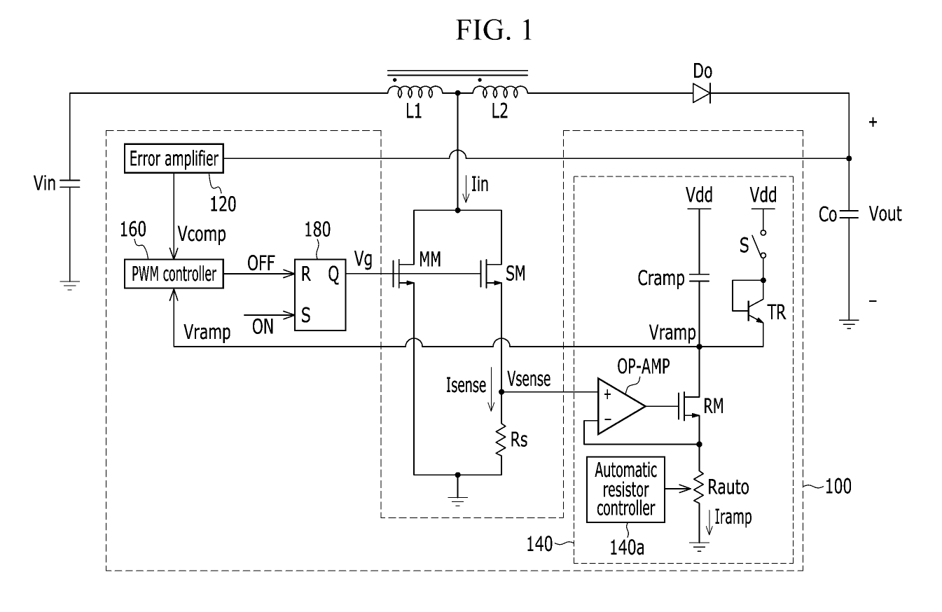

FIG. 1 shows a converter according to an exemplary embodiment of the present invention. As shown in FIG. 1, the converter includes a switch control circuit 100, a first inductor L1, a second inductor L2, a main switch (MM), a sense switch (SM), a sense resistor (Rs), an output diode (Do), and an output capacitor (Co).

The main switch (MM) and the sense switch (SM) may generally include n channel type metal oxide semiconductor field effect transistors (MOSFETs). It should be noted that the main switch (MM) and sense switch (SM) may include other types of transistors such as P channel type MOSFETs or BJTs.

A gate voltage (Vg) is applied to gate electrodes of the main switch (MM) and the sense switch (SM) from the switch control circuit 100 and turn-on/off operations are performed. In this instance, the turn-on/off operation is generally performed by the main switch (MM), and the sense switch (SM) is used to sense an amount of a current (Iin). Gates and drains of the main switch (MM) and the sense switch (SM) are connected to each other, and the current (Iin) is divided by a predetermined ratio according to a channel ratio of the switches (MM, SM). That is, when the channel ratio of the main switch (MM) and the sense switch (SM) is 1000:1, most current (Iin) flows through the main switch (MM) and less current (Isense=1/10001*in) flows through the sense switch (SM). A sense resistor (Rs) is connected between a source of the sense switch (SM) and a ground, and a sense current (Isense) is converted into a sense voltage (Vsense) by the sense resistor (Rs).

A first end of the first inductor L1 is connected to an input voltage Vin, and a second end thereof is connected to a first end of the second inductor L2 and drains of the switches (MM, SM). A first end of the second inductor L2 is connected to a second end of the first inductor, and a second end thereof is connected to an anode of the output diode (Do). The first inductor L1 and the second inductor L2 are coupled with each other by a predetermined number of turns and store input energy. A smoothing capacitor (not shown) for stabilizing a voltage can be connected to both ends of the input voltage Vin.

An anode of the output diode (Do) is connected to a second end of the second inductor L2 and a cathode thereof is connected to the first end of the output capacitor (Co). The output diode (Do) controls a current path to flow in one direction.

A first end of the output capacitor (Co) is connected to a cathode of the output diode (Do) and a second end thereof is grounded. A voltage at the output capacitor (Co) is a final output voltage (Vout) and is supplied to a load.

The switch control circuit 100 receives output voltage (Vo) and sense voltage (Vsense) information to control a turn-on/off operation of the switches (MM, SM), and maintains a stable output voltage (Vout).

As shown in FIG. 1, the switch control circuit 100 includes an error amplifier 120, a ramp voltage generator 140, a PWM controller 160, and an SR flip-flop 180.

The error amplifier 120 receives an output voltage (Vout) and amplifies a difference between a predetermined reference voltage and the output voltage (Vout) to output an error voltage (Vcomp). The error voltage (Vcomp) represents information that corresponds to the output voltage (Vout).

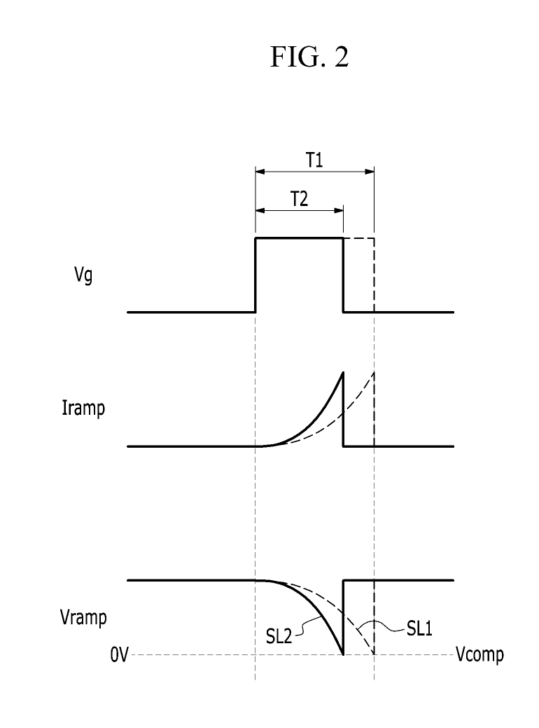

The ramp voltage generator 140 receives a sense voltage (Vsense) and generates a predetermined ramp voltage (Vramp) that corresponds to the sense voltage (Vsense). A detailed operation of the ramp voltage generator 140 according to an exemplary embodiment of the present invention will be described in detail with reference to FIG. 2.

The PWM controller 160 receives an error voltage (Vcomp) and a ramp voltage (Vramp) to compare them, and outputs an off signal (OFF) for turning off the main switch (MM) according to the comparison result. That is, the PWM controller 160 outputs a high-level off signal (OFF) when the ramp voltage (Vramp) becomes less than the error voltage (Vcomp), and it outputs a low-level off signal (OFF) when the ramp voltage (Vramp) is greater than the error voltage (Vcomp).

The SR flip-flop 180 includes a set terminal (S) for receiving an On pulse signal (ON) and a reset terminal (R) for receiving an Off signal (OFF), it outputs a high-level signal according to an input signal to the set terminal (S), and it outputs a low-level signal according to an input signal to the reset terminal (R).

An output signal of the SR flip-flop 180 is shown as a gate voltage (Vg), and a gate driver (not shown) for generating the gate voltage (Vg) according to the output signal of the SR flip-flop 180 can be further included.

A configuration and operation of the ramp voltage generator 140 will now be described with reference to FIG. 1 and FIG. 2. FIG. 2 shows a principle for a ramp voltage generator 140 according to an exemplary embodiment of the present invention to generate a ramp voltage (Vramp).

As shown in FIG. 1, the ramp voltage generator 140 includes a differential amplifier (OP-AMP), a switch (RM), a variable resistor (Rauto), a capacitor (Cramp), a transistor (TR), a switch (S), and an automatic resistor controller 140a.

A non-inverting terminal (+) of the differential amplifier (OP-AMP) is connected to a source of the sense switch (SM), an inverting terminal (−) thereof is connected to a source of the switch (RM), and an output terminal thereof is connected to a gate of the switch (RM).

A first end of the capacitor (Cramp) is connected to a power voltage (Vdd) and a second end thereof is connected to a drain of the switch (RM). A first end of the switch (S) is connected to the power voltage (Vdd), and a second end thereof is connected to a collector of the transistor (TR). A base and a collector of the transistor (TR) are connected to each other, and an emitter thereof is connected to a second end of the capacitor (Cramp).

A first end of the variable resistor (Rauto) is connected to a source of the switch (RM), and a second end thereof is grounded. The automatic resistor controller 140a changes resistance of the variable resistor (Rauto) in a predetermined condition.

Before the gate voltage (Vg) becomes high-level (i.e., from a low level), the switch (S) is turned on to charge the capacitor (Cramp) in advance, and the ramp voltage (Vramp) becomes Vdd-Vbe. Here, Vbe represents a voltage between a base and an emitter of the transistor (TR). When the gate voltage (Vg) becomes high-level, the main switch (MM) and the sense switch (SM) are turned on and the sense voltage (Vsense) is gradually increased. Because of a characteristic of a differential amplifier (OP-AMP), a voltage at a non-inverting terminal (+) corresponds to a voltage at an inverting terminal (−) so the ramp current (Iramp) becomes Vsense/Rauto and it is gradually increased as shown in FIG. 2. As the ramp current (Tramp) is gradually increased, the capacitor (Cramp) is discharged and the ramp voltage (Vramp) is gradually reduced from the voltage Vdd-Vbe.

In the ramp voltage generator 140, the ramp voltage (Vramp) may not have a predetermined first slope SL1 because of mismatching between the main switch (MM) and the sense switch (SM), a change of a characteristic of circuit elements (Rs, Rauto, Cramp, and TR), and an offset of the differential amplifier (OP-AMP). That is, as shown in FIG. 2, the ramp voltage (Vramp) must be gradually reduced with the predetermined first slope SL1 and it can be gradually reduced with a second slope (SL2) that is shown with a dotted line. When the slope of the ramp voltage (Vramp) is greater than the predetermined slope (SL2>SL1), the ramp voltage (Vramp) meets a minimum value (ground that is 0 V) of the error voltage (Vcomp) more quickly so an Off signal (OFF) can be output as high-level while it is not a predetermined maximum current level. Here, the minimum value 0 V of the error voltage (Vcomp) corresponds to information for showing a supply of the maximum current level.

When the slope of the ramp voltage (Vramp) is changed as described above, the minimum value of the error voltage (Vcomp) can be reduced to be less than the ground voltage 0 V so as to supply the maximum current level, and the ramp voltage (Vramp) cannot be reduced to be less than the ground voltage 0 V because it is the output of the error amplifier 120.

Therefore, the gate voltage (Vg) must be high-level during a first period T1 so as to supply the maximum current level and it is high-level during a second period T2 because of a limit of the minimum value of the error voltage (Vcomp). Energy stored in the inductor L1 is reduced to be less than a predetermined value so the maximum output current is reduced and the stable output voltage (Vout) cannot be acquired.

When the automatic resistor controller 140a satisfies a predetermined condition, it changes resistance of the variable resistor (Rauto) and accordingly changes the slope of the ramp voltage (Vramp). That is, the slope of the ramp voltage (Vramp) is changed by resistance of the variable resistor (Rauto), and the automatic resistor controller 140a changes of the slope of the ramp voltage (Vramp) by changing the resistance of the variable resistor (Rauto). Accordingly, the converter can acquire the stable output voltage (Vout).

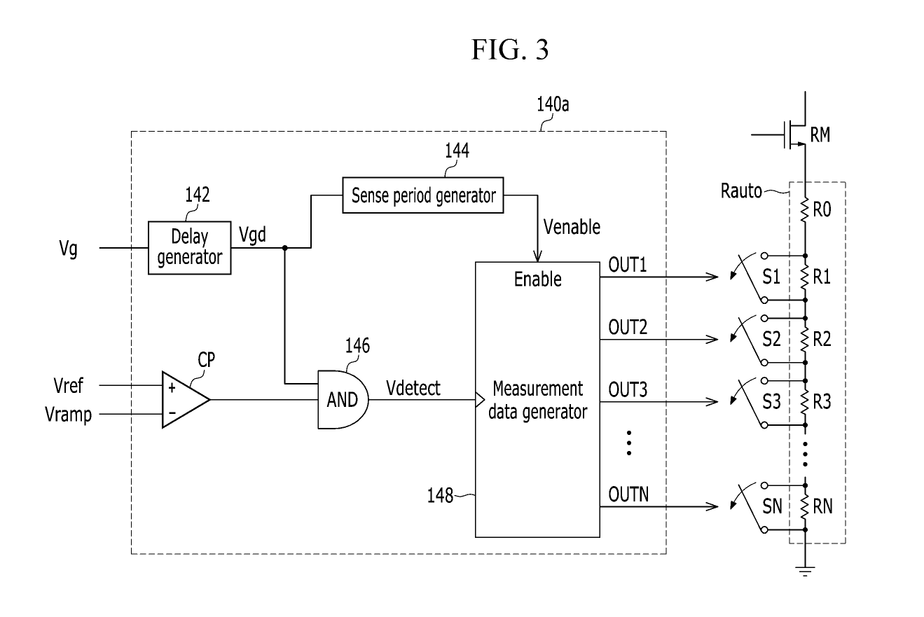

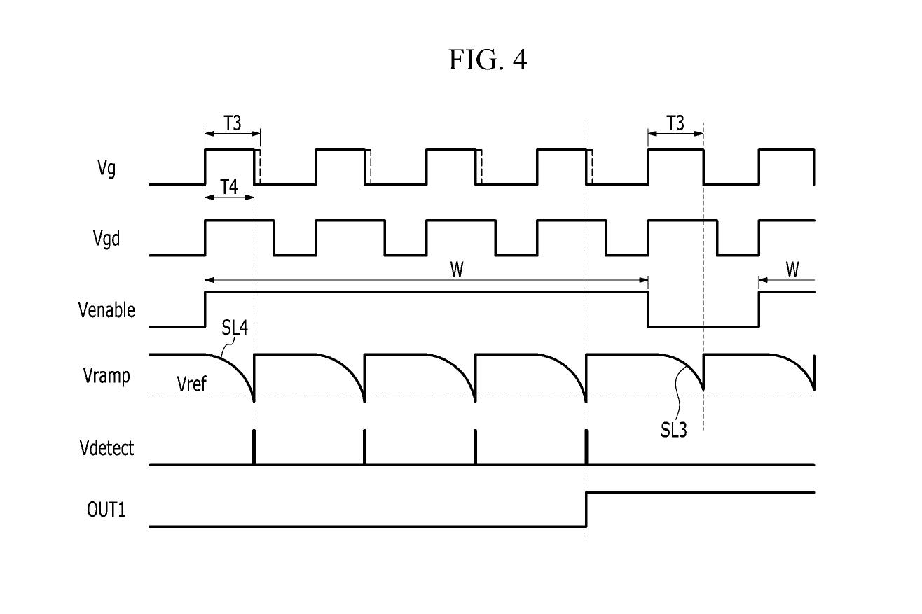

A method for an automatic resistor controller 140a to change resistance of a variable resistor (Rauto) will now be described with reference to FIG. 3 and FIG. 4.

FIG. 3 shows an internal configuration of an automatic resistor controller 140a according to an exemplary embodiment of the present invention, and FIG. 4 shows a timing diagram for showing waveforms of respective signals in an automatic resistor controller 140a according to an exemplary embodiment of the present invention.

As shown in FIG. 3, the automatic resistor controller 140a includes a delay generator 142, a sense period generator 144, a comparator (CP), an AND gate 146, and a measurement data generator 148.

The delay generator 142 receives a gate voltage (Vg), and delays the gate voltage (Vg) for a predetermined time to output a delay signal (Vgd). That is, as shown in FIG. 4, the delay signal (Vgd) represents a signal generated by delaying the gate voltage (Vg) for a predetermined time.

The sense period generator 144 receives the delay signal (Vgd) and generates a sense period enable signal (Venable) having a predetermined window W. The sense period enable signal (Venable), shown in FIG. 4, maintains the high level until the fifth high pulse of the delay signal (Vgd) appears, and the window W can be increased or reduced. Further, the sense period generator 144 can generate the sense period enable signal (Venable) by using the gate voltage (Vg) instead of using the delay signal (Vgd).

The comparator (CP) receives a reference voltage (Vref) through a non-inverting terminal (+) and a ramp voltage (Vramp) through an inverting terminal (−). The comparator (CP) outputs a high-level signal when the ramp voltage (Vramp) is less than a reference voltage (Vref). In this instance, the reference voltage (Vref) represents a level that is established to detect a case in which the slope of the ramp voltage (Vramp) is changed and sufficient energy is not charged in the inductor L1, and it can be set to be a level that is a little greater than the ground voltage 0 V.

The AND gate 146 receives the delay signal (Vgd) and the output signal of the comparator (CP) and outputs a high-level signal when both signals are high-level. That is, as shown in FIG. 4, a detection signal (Vdetect) that is the output signal of the AND gate 146 is a high-level signal when the ramp voltage (Vramp) is less than the reference voltage (Vref) and the delay signal (Vgd) is high-level.

The measurement data generator 148 receives the detection signal (Vdetect) and the sense period enable signal (Venable), and outputs a high-level signal to a first output terminal OUT1 when the detection signal (Vdetect) has N continuous pulses during an interval W in which the sense period enable signal (Venable) is high-level. The measurement data generator 148 outputs a high-level signal to the second output terminal OUT2 when the detection signal (Vdetect) has N continuous pulses in the subsequent high-level interval of the sense period enable signal (Venable). Through the above-described operation, the measurement data generator 148 can output a high-level signal up to the N-th output terminal (OUTN). The N times are set to be 4 in FIG. 4, and they are changeable.

As shown in FIG. 4, the pulse of the detection signal (Vdetect) is continuously generated four times during the interval W in which the sense period enable signal (Venable) is high-level, and the measurement data generator 148 outputs a high-level signal to the first output terminal OUT1.

As shown in FIG. 3, the variable resistor (Rauto) is realized by connecting a plurality of resistors (Ro, R1, R2, R3, . . . RN) in series, and first to N-th switches (S1, S2, S3, . . . SN) are coupled in parallel at the first to N-th resistors (R1, R2, . . . RN). The first to N-th switches (S1, S2, S3, . . . SN) are connected to the output terminals (OUT1, OUT2, OUT3, . . . OUTN) of the measurement data generator 148, and when they receive high-level signals from the output terminals (OUT1, OUT2, OUT3, . . . OUTN) while they are set in advance to be turned on, they are switched to the turn-off states. When the first to N-th switches (S1, S2, S3, . . . SN) are turned on, the variable resistor (Rauto) becomes Ro. When the measurement data generator 148 outputs a high-level signal to the first output terminal OUT1, the first switch S1 is switched to the turn-off state from the turn-on state, and the variable resistor (Rauto) has a value of Ro+R1. When the first to N-th switches (S1, S2, S3, . . . SN) are switched to the turn-off states, the variable resistor (Rauto) has a value of Ro+R1+R2+R3+ . . . RN.

The resistance of the variable resistor (Rauto) is changed by control of the variable resistor controller 140a, and when the resistance of the variable resistor (Rauto) is changed, the slope of the ramp voltage (Vramp) is changed.

Referring to FIG. 4, when the slope of the ramp voltage (Vramp) is changed to the slope of SL4 that is greater than the predetermined value of SL3, the gate voltage (Vg) maintains the high level during an interval T4 that is shorter than the interval T3. In this instance, the sense voltage (Vdetect) has a pulse signal, and when the sense voltage (Vdetect) has four continuous pulses during an interval W in which the sense period enable signal (Venable) is high-level, the first output OUT1 of the measurement data generator 148 becomes high-level. When the first output OUT1 is high-level, the first switch S1 is turned off, resistance of the variable resistor (Rauto) is changed to the value of R0+R1, and the slope of the ramp voltage (Vramp) is changed to SL3 (predetermined value). When the slope of the ramp voltage (Vramp) is changed to the predetermined S3, the gate voltage (Vg) maintains the high level for the predetermined interval T3 and also maintains the constant maximum current level to acquire a stable output voltage (Vout).

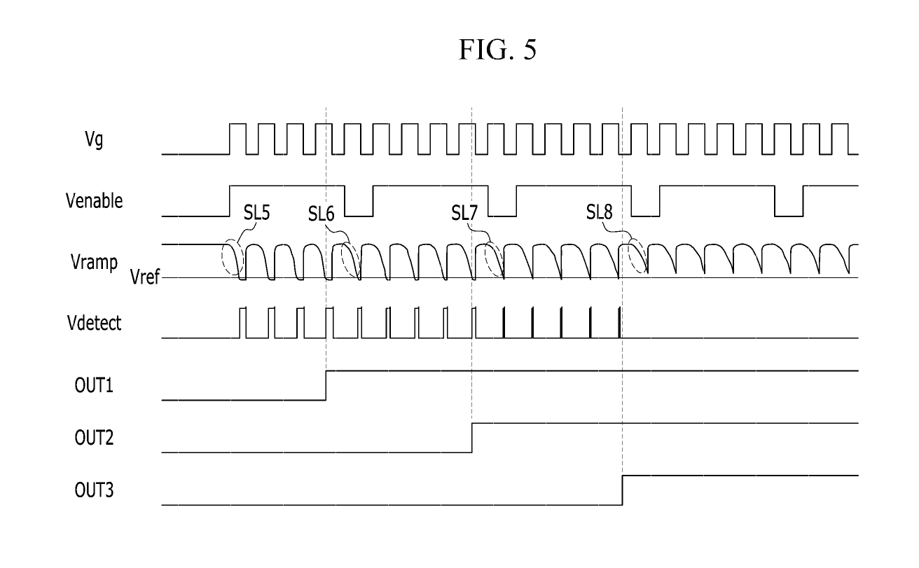

FIG. 5 shows a diagram for sequentially changing a slope of a ramp voltage (Vramp).

As shown in FIG. 5, when the detection signal (Vdetect) has four continuous pulses during an interval in which the sense period enable signal (Venable) is high-level, the first output terminal OUT1 is switched to the high level. When the first output terminal OUT1 is high-level, the switch S1 is turned off and resistance of the variable resistor (Rauto) is changed to R0+R1. When the resistance of the variable resistor (Rauto) is changed to R0+R1 from R0, the slope of the ramp voltage (Vramp) is changed to SL6 from SL5 (SL6<SL5). When the detection signal (Vdetect) has four continuous pulses during the subsequent high-level interval of the sense period enable signal (Venable), the second output terminal OUT2 becomes high-level and resistance of the variable resistor (Rauto) is changed to R0+R1+R2. The slope of the ramp voltage (Vramp) is changed to SL7 from SL6 (SL7<SL6). When the detection signal (Vdetect) again has four continuous pulses during an interval in which the sense period enable signal (Venable) is high-level, the third output terminal OUT3 becomes high-level. When the third output terminal OUT3 becomes high-level, resistance of the variable resistor (Rauto) is changed to R0+R1+R2+R3, the slope of the ramp voltage (Vramp) is changed to SL8 from SL7 (SL8<SL7), and finally the ramp voltage (Vramp) is restored to a predetermined slope SL8 and there is no interval that is less than the reference voltage (Vref).

Accordingly, the slope of the ramp voltage (Vramp) is changed to transmit sufficient energy to the inductor L1, and the maximum current level is maintained to acquire the stable output voltage (Vout).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A converter comprising:
at least one inductor configured to store energy of an input end and to provide the stored energy to an output end;
a first switch coupled between the inductor and a ground; and
a switch control circuit coupled to the first switch and configured to control the first switch based on a comparison between a ramp voltage and a first voltage, the ramp voltage corresponding to a current flowing through the first switch and the first voltage corresponding to an output voltage of the output end, the switch control circuit being further configured to change a slope of the ramp voltage by comparing the ramp voltage and a first reference voltage.

2. The converter of claim 1, wherein, in a first condition in which the ramp voltage is less than the first reference voltage, the switch control circuit is configured to adjust a first slope of the ramp voltage to a second slope that is gentler than the first slope.

3. The converter of claim 2, wherein the switch control circuit is configured to adjust a slope of the ramp voltage to the second slope from the first slope when the first condition continuously occurs at least twice.

4. The converter of claim 1, wherein the switch control circuit comprises a ramp voltage generator configured to generate the ramp voltage, the ramp voltage generator comprising:
a capacitor having a first end coupled to a power voltage and configured to charge a predetermined voltage;
a second switch having a first end coupled to a second end of the capacitor;
a variable resistor coupled between a second end of the second switch and a ground;
a differential amplifier having a first input end for receiving information on the current, a second input end coupled to the second end of the second switch, and an output end coupled to a control end of the second switch; and
an automatic resistor controller configured to change resistance of the variable resistor,
wherein a voltage at the second end of the capacitor is the ramp voltage.

5. The converter of claim 4, wherein, in a first condition in which the ramp voltage is less than the first reference voltage, the automatic resistor controller is configured to control the variable resistor to increase resistance of the variable resistor.

6. The converter of claim 5, wherein the variable resistor includes a first resistor and a second resistor coupled to one another in series, the ramp voltage generator further comprising a third switch coupled to both ends of the second resistor, and the automatic resistor controller being configured to turn off the third switch in the first condition.

7. The converter of claim 5, wherein the automatic resistor controller includes:
a delay generator configured to delay a signal input to a control end of the first switch for a predetermined time;
a comparator configured to receive and compare the ramp voltage and the first reference voltage with one another;
an AND gate configured to receive a delay signal from of the delay generator and a comparison result from the comparator;
a sense period generator configured to generate a signal having a high level during a first interval; and
a measurement data generator configured to receive outputs of the AND gate and the sense period generator and to output a signal configured to turn off the third switch when the first condition is satisfied during the first interval.

8. The converter of claim 4, wherein the ramp voltage generator further comprises:
a transistor having a first end coupled to the second end of the capacitor and a second end coupled to the control end; and
a third switch coupled between the power voltage and the second end of the transistor.

9. The converter of claim 1, wherein the switch control circuit comprises:
an error amplifier configured to generate the first voltage by amplifying a difference between the output voltage and a second reference voltage; and
a PWM controller configured to compare the first voltage and the ramp voltage and to output a signal for turning off the first switch.

10. The converter of claim 3, wherein, when the slope of the ramp voltage is adjusted to the second slope and satisfies the first condition, the switch control circuit is configured to adjust a slope of the ramp voltage to a third slope that is gentler than the second slope.

11. The converter of claim 1, wherein the inductor comprises a first inductor having a first end coupled to the input end and a second inductor having a first end coupled to a second end of the first inductor, the converter further comprising:
a second switch coupled in parallel to the first switch; and
a resistor having a first end coupled to the second switch and a second end coupled to the ground,
wherein the first switch is coupled between the second end of the first inductor and the ground, and a voltage at the first end of the resistor is supplied to the switch control circuit.

12. A method for driving a converter comprising:
providing an inductor having a first end coupled to an input end;
providing a switch coupled between a second end of the inductor and a ground;
generating a first voltage corresponding to an output voltage of an output end;
generating a ramp voltage corresponding to a current flowing through the switch;
comparing a ramp voltage and a first reference voltage and adjusting a slope of the ramp voltage; and
comparing the ramp voltage and the first voltage and controlling the switch based on the comparison.

13. The method of claim 12, wherein adjusting a slope of the ramp voltage includes:
determining whether the ramp voltage is less than the first reference voltage; and
adjusting a first slope of the ramp to a second slope that is gentler than the first slope if the ramp voltage is less than the first reference voltage.

14. The method of claim 13, wherein, after the slope of the ramp voltage is adjusted to the second slope, adjusting a slope of the ramp voltage further comprises adjusting a slope of the ramp voltage to a third slope that is gentler than the second slope when the ramp voltage is less than the first reference voltage.

15. A switch control circuit in a converter comprising an inductor having a first end coupled to an input end and a switch coupled between the inductor and a ground, the switch control circuit comprising:
a ramp voltage generator configured to generate a ramp voltage corresponding to a current flowing through the switch; and
a PWM controller configured to compare a first voltage corresponding to an output voltage of the converter and the ramp voltage and further configured to generate a signal for turning off the first switch,
wherein the ramp voltage generator is configured to compare the ramp voltage and the first reference voltage to adjust a slope of the ramp voltage based on the comparison.

16. The switch control circuit of claim 15, wherein the ramp voltage generator is configured to adjust a first slope of the ramp voltage to a second slope that is gentler than the first slope when the ramp voltage is less than the first reference voltage.

17. The switch control circuit of claim 15, wherein the ramp voltage generator comprises:
a capacitor having a first end coupled to a power voltage and configured to be charged with a predetermined voltage;
a first switch having a first end coupled to a second end of the capacitor;
a variable resistor coupled between a second end of the first switch and a ground;
a differential amplifier having a first input end for receiving information on the current, a second input end coupled to a second end of the first switch, and an output end coupled to a control end of the second switch; and
an automatic resistor controller configured to adjust resistance of the variable resistor, and
wherein a voltage at a second end of the capacitor is the ramp voltage.

18. The switch control circuit of claim 17, wherein the variable resistor comprises a plurality of resistors coupled in series with one another, the ramp voltage generator further comprising a plurality of switches coupled in parallel to the plurality of resistors, and the automatic resistor controller being configured to turn off at least one of the plurality of switches to adjust resistance of the variable resistor when the ramp voltage is less than the first reference voltage.

19. The switch control circuit of claim 18, wherein the automatic resistor controller comprises:
a delay generator configured to delay a signal that is input to a control end of the switch for a predetermined time;
a comparator configured to receive and compare the ramp voltage and the first reference voltage with one another;
an AND gate configured to receive a delay signal from the delay generator and a comparison result from the comparator;
a sense period generator configured to generate a signal having a high level during a first interval; and
a measurement data generator configured to receive outputs of the AND gate and the sense period generator, and to output a signal configured to turn off at least one of the plurality of switches when the ramp voltage is less than the first reference voltage during the first interval.

20. The switch control circuit of claim 17, wherein the ramp voltage generator further comprises:
a transistor having a first end coupled to a second end of the capacitor and a second end coupled to a control end; and
a second switch coupled between the power and the second end of the transistor.
